(19) United States
(12) Patent Application Publication
(10) Pub. No.: US 2011/0119361 A1
(43) Pub. Date: May 19, 2011

(54) SYSTEM AND METHOD FOR MANAGING REDACTED ELECTRONIC DOCUMENTS USING CALLBACK TRIGGERS

(75) Inventors: Alfredo C. Issa, Apex, NC (US); Richard J. Walsh, Raleigh, NC (US)

(73) Assignee: OTO TECHNOLOGIES, LLC, Raleigh, NC (US)

(21) Appl. No.: 12/619,898

(22) Filed: Nov. 17, 2009

(51) Int. Cl. G06F 15/173; G06F 3/00

(52) U.S. Cl. 709/223; 715/749

(57) ABSTRACT

Systems and methods for managing redacted electronic documents using callback triggers are provided. In one embodiment, a user device obtains a redacted version of an electronic document, which is referred to herein as a redacted electronic document, and a callback trigger associated with a redacted portion of the redacted electronic document. While a user at the user device is consuming, or reading, the electronic document, a triggering event for the callback trigger is detected. In response to detecting the triggering event, a callback action defined by the callback trigger is performed in order for the user to gain access to the redacted portion of the redacted electronic document. Once the user of the user device has acquired rights to access the redacted portion of the redacted electronic document, the user is enabled to access the redacted portion of the redacted electronic document.

### FIELD OF THE DISCLOSURE

The present disclosure relates to redacted electronic documents and more particularly relates to use of callback triggers to enable a consumer to gain access to a redacted portion of the redacted electronic document.

### BACKGROUND

In today's digital world, electronic documents are shared or otherwise distributed from a number of sources. For example, electronic documents are becoming increasingly popular with the success of devices such as the Amazon Kindle® e-reader. There is a desire to leverage the success of such devices to enhance the ability of content creators or distributors to control access to their electronic documents as well as to enable consumers to quickly and easily gain access rights to restricted content.

### SUMMARY OF THE DETAILED DESCRIPTION

The present disclosure is related to managing redacted electronic documents using callback triggers. In one embodiment, a user device obtains a redacted version of an electronic document, which is referred to herein as a redacted electronic document, and a callback trigger associated with a redacted portion of the redacted electronic document. While a user at the user device is consuming, or reading, the electronic document, a triggering event for the callback trigger is detected. In response to detecting the triggering event, a callback action defined by the callback trigger is performed in order for the user to gain access to the redacted portion of the redacted electronic document. In one embodiment, the callback action is establishing a voice communication session between the user of the user device and a person or entity having power to grant access rights to the user for the redacted portion of the redacted electronic document specified by the callback trigger. Once the user of the user device has acquired rights to access the redacted portion of the redacted electronic document, the user is enabled to access the redacted portion of the redacted electronic document.

In one embodiment, the electronic document is redacted to provide the redacted electronic document by first determining a portion of the electronic document to be redacted. Then, the portion of the electronic document to be redacted is removed from the electronic document to thereby provide the redacted electronic document. In addition, within the redacted electronic document, the redacted portion may be replaced with an item representative of the redacted portion such as, but not limited to, a blacked-out region, an advertisement, an indicator that is indicative of content of the redacted portion, a collapsible heading, a distorted version of the redacted portion, or a place holder that provides a reason that the redacted portion is redacted (e.g., Confidential Information). The portion of the electronic document to be redacted may be determined by manual selection of the portion of the electronic document to be redacted by a user (e.g., creator of the electronic document, representative of the creator of the electronic document, or representative of a distributor of the electronic document). Alternatively, the portion of the electronic document to be redacted may be determined automatically based on one or more redaction criteria.

In another embodiment, the electronic document is redacted by first determining a portion of the electronic document to be redacted. Then, a Digital Rights Management (DRM) scheme is used to control access to the electronic document such that the user does not have access to the portion of the electronic document that has been redacted to thereby provide the redacted electronic document. The portion of the electronic document to be redacted may be determined by manual selection of the portion of the electronic document to be redacted by a user (e.g., creator of the electronic document, representative of the creator of the electronic document, or representative of a distributor of the electronic document). Alternatively, the portion of the electronic document to be redacted may be determined automatically based on one or more redaction criteria.

Those skilled in the art will appreciate the scope of the present invention and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the invention, and together with the description serve to explain the principles of the invention.

FIG. 1 illustrates a system for redacting electronic documents and managing access to the resulting redacted electronic documents using callback triggers according to one embodiment of the present disclosure;

FIG. 2 illustrates the operation of the system of FIG. 1 according to one embodiment of the present disclosure;

FIG. 3 is a flow chart for a process for redacting an electronic document and associating callback triggers with one or more redacted portions of the redacted electronic document according to one embodiment of the present disclosure;

FIG. 4 illustrates the operation of the system of FIG. 1 according to another embodiment of the present disclosure;

FIGS. 5A and 5B graphically illustrate a redacted electronic document wherein redacted portions are replaced by blacked-out regions according to one embodiment of the present disclosure;

FIG. 6 graphically illustrates a redacted electronic document wherein a redacted portion is replaced by an advertisement according to one embodiment of the present disclosure;

FIG. 7 graphically illustrates a redacted electronic document wherein a redacted portion is replaced by an indicator that is indicative of content of the redacted portion according to one embodiment of the present disclosure;

FIG. 8 graphically illustrates a redacted electronic document wherein redacted portions are replaced by collapsible headings according to one embodiment of the present disclosure;

FIG. 9 illustrates a system for redacting electronic documents and managing access to the resulting redacted electronic documents using callback triggers according to another embodiment of the present disclosure;

FIG. 10 illustrates the operation of the system of FIG. 9 according to one embodiment of the present disclosure;

FIG. 11 illustrates the operation of the system of FIG. 9 according to another embodiment of the present disclosure;

FIG. 12 is a block diagram of the central system of FIGS. 1 and 9 according to one embodiment of the present disclosure;

FIG. 13 is a block diagram of the user device of the consumer of FIGS. 1 and 9 according to one embodiment of the present disclosure; and

FIG. 14 is a block diagram of the user device of the creator of the electronic document of FIG. 9 according to one embodiment of the present disclosure.

### DETAILED DESCRIPTION

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

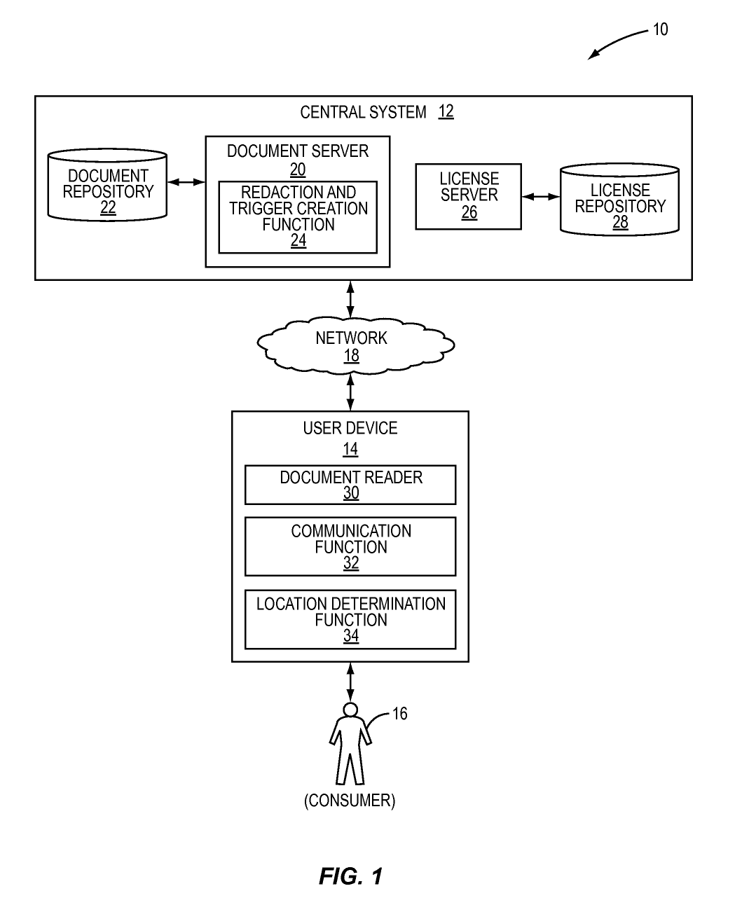

FIG. 1 illustrates a system 10 for distribution and management of redacted electronic documents using callback triggers according to one embodiment of the present disclosure. The system 10 includes a central system 12 connected to a user device 14 having an associated user 16 via a network 18. The network 18 may be any type or combination of networks and may include wireless components, wired components, or both wired and wireless components. For example, the network 18 may be a distributed, global network such as the Internet, where the user device 14 is connected to the network 18 via a local wireless connection (e.g., IEEE 802.11x connection), a wireless cellular connection formed over a cellular network (e.g., 3G or 4G network such as GSM network, W-CDMA network, LTE network, WiMAX network, etc.), or a wired connection (e.g., Ethernet connection).

The central system 12 is implemented as a physical server or a number of physical servers operating in a collaborative manner for load sharing and/or redundancy. The central system 12 includes a document server 20 associated with a document repository 22. The document server 20 is implemented in software, hardware, or a combination thereof and generally operates to serve redacted versions of electronic documents stored in the document repository 22 to user devices such as the user device 14. The electronic documents stored in the document repository 22 are electronic books, electronic magazines, electronic newspapers, or other documents in electronic format. Note that as used herein, an electronic document is not a web page, article appearing as text on a webpage, a blog, or other web-based content. However, in another embodiment, the systems and methods described herein may be used to distribute and manage redacted web-based content (e.g., web pages, blogs, or the like). It should also be noted that while the discussion herein focuses on electronic documents, the systems and methods described herein may also be used to provide and utilize callback triggers for media items such as, for example, audio content items such as audio books, podcasts, or the like, and/or video content items such as video clips, movies, television programs, or the like.

In addition, in this embodiment, the document server 20 includes a redaction and trigger creation function 24. The redaction and trigger creation function 24 generally operates to redact the electronic documents in the document repository 22 to provide redacted versions of the electronic documents, which are referred to herein as redacted electronic documents. In addition, the redaction and trigger creation function 24 associates callback triggers with redacted portions of the redacted electronic documents. As discussed below in detail, the callback triggers enable users, such as the user 16, to gain access to redacted portions of the redacted electronic documents.

In one embodiment, the central system 12 also includes a license server 26. Note, however, that the license server 26 may alternatively be hosted by a remote system (i.e., implemented outside of the central system 12). The license server 26 is implemented in software, hardware, or a combination thereof and generally operates to issue licenses for the electronic documents stored in the document repository 22 under control of the document server 20. As discussed below, licenses issued by the license server 26 can be used to provide the redacted electronic documents by preventing users, such as the user 16, from accessing redacted portions of the redacted electronic documents. In addition, licenses issued by the license server 26 can be used to provide access to redacted portions of the redacted electronic document once the users have obtained the appropriate access rights through the use of the callback triggers. Licenses may be stored in a license repository 28 that is accessible to the license server 26

The user device 14 is a hardware device such as, but not limited to, an e-reader such as or similar to the Amazon Kindle® e-reader, a smart phone such as or similar to the Apple® iPhone, a personal computer, or the like. Note that while only one user device 14 is illustrated in FIG. 1 for clarity and ease of discussion, it should be appreciated that the central system 12 preferably serves numerous user devices 14. The user device 14 includes a document reader 30 and a communication function 32. The document reader 30 may be implemented in software, hardware, or a combination thereof and generally operates to obtain and view electronic documents. In addition, as discussed below in detail, the document reader 30 enables the user 16 to obtain redacted electronic documents from the central system 12 and gain access to redacted portions of the redacted electronic documents through the use of callback triggers. The communication function 32 is implemented in hardware or a combination of software and hardware. In general, the communication function 32 includes a hardware component for communicatively coupling the user device 14 to the network 18 via a wired or wireless connection. In addition, as discussed below, the communication function 32 enables the document reader 30 to perform callback actions in order for the user 16 to gain access to redacted portions of redacted electronic documents.

In one embodiment, the user device 14 also includes a location determination function 34. The location determination function 34 may be implemented in software, hardware, or a combination thereof and generally operates to obtain a current location of the user device 14. The current location of the user device 14 may be expressed as a pair of latitude and longitude coordinates, and optionally an altitude, or any other data capable of expressing the location of the user device 14 in either two-dimensional or three-dimensional space. In one embodiment, the location determination function 34 is a Global Positioning System (GPS) receiver. In another embodiment, the location determination function 34 is a software application that operates to obtain the current location of the user device 14 from an external source. For example, if the user device 14 is a mobile phone, the external source of the current location of the user device 14 may be a cellular telecommunications network. Alternatively, the location determination function 34 may determine the location of the user device 14 via triangulation. Note, however, that the embodiments of the location determination function 34 described above are exemplary and not intended to limit the scope of the present disclosure. It should be appreciated that the location determination function 34 may be any type of software and/or hardware capable of determining the location of the user device 14.

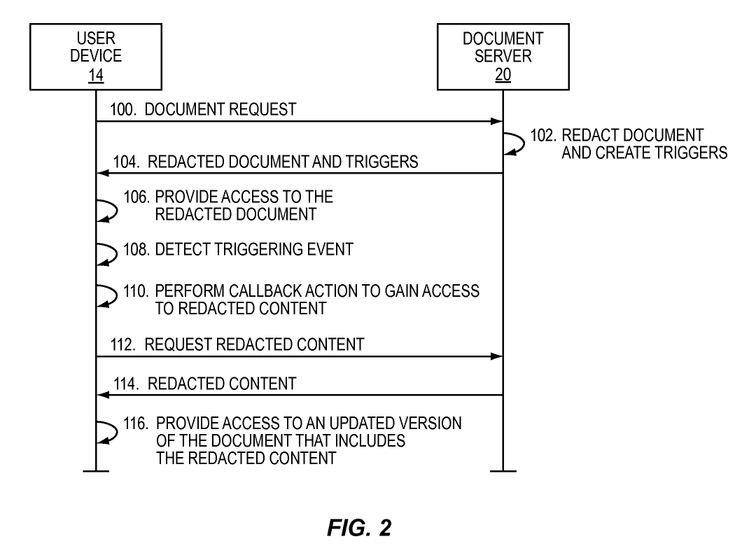

FIG. 2 illustrates of the operation of the system 10 of FIG. 1 according to one embodiment of the present disclosure. First, the user device 14 sends a document request to the document server 20 of the central system 12 (step 100). The document request is a request for a specific electronic document. In response to receiving the document request, the document server 20 redacts the requested electronic document to provide a redacted electronic document and creates one or more callback triggers for the redacted electronic document (step 102). In this embodiment, the redaction and trigger creation function 24 of the document server 20 redacts the requested electronic document by first determining one or more portions of the requested electronic document to be redacted and then removing the one or more portions to be redacted from the requested electronic document to thereby create the redacted electronic document. The portions of the electronic document that are redacted are referred to herein as redacted portions. In the redacted electronic document, each redacted portion may be replaced with a blacked-out region, an advertisement, an indicator that is indicative of type of content or subject matter of the content in the redacted portion, a collapsible heading, a distorted version of the redacted portion, a place holder that provides a reason that the redacted portion is redacted, or the like.

In addition, the redaction and trigger creation function 24 of the document server 20 associates a callback trigger with each of the redacted portions of the redacted electronic document. Each callback trigger is associated with one or more of the redacted portions of the redacted electronic document and enables the user 16 to obtain access rights to the one or more redacted portions of the redacted electronic document with which the callback trigger is associated. More specifically, each callback trigger defines a triggering event and a callback action. The triggering event is defined as the occurrence of a specified user action at a specified location within the redacted electronic document. The location for the triggering event for a callback trigger corresponds to a location of the corresponding redacted portion within the redacted electronic document. The user action may be any user action such as, but not limited to, user selection, scrolling, dwelling, gazing, or the like. Detection of such user actions may be done using an appropriate known technique. For example, the triggering event may be user selection of an item representing the redacted portion in the redacted electronic document (e.g., blacked-out region, advertisement, indicator, collapsible heading, distorted version of the redacted portion, or a place holder that provides a reason that the redacted portion is redacted), scrolling past the location of the redacted portion in the redacted electronic document, dwelling on the location of the redacted portion in the redacted electronic document for a defined amount of time, gazing at the location of the redacted portion in the redacted electronic document, or the like. The callback action is preferably establishment of a voice communication session between the user 16 and a specified person or entity having the power to grant access rights to the redacted portion of the redacted electronic document to the user 16. The voice communication session may be any type of voice communication session such as, but not limited to, a telephone call, a Voice over Internet Protocol (VoIP) connection, or the like. Note that as used herein, a voice communication session includes an embodiment where a voice communication session is used to contact an Interactive Voice Response (IVR) or similar system that is enabled to grant access rights via an automated process. In an alternative embodiment, the callback action may be contacting an e-commerce service associated with or included within the central system 12 to perform an e-commerce transaction to gain access to the redacted portion of the redacted electronic document.

Next, the document server 20 of the central system 12 returns the redacted electronic document and the one or more callback triggers associated with the one or more redacted portions of the redacted electronic document to the user device 14 (step 104). The document reader 30 of the user device 14 then provides the user 16 access to the redacted electronic document (step 106). While the user 16 is consuming, or reading, the redacted electronic document, the document reader 30 detects an occurrence of the triggering event for one of the callback triggers (step 108). In response to detecting the triggering event, the document reader 30 performs the callback action for the callback trigger in order for the user 16 to gain access rights to the one or more redacted portions associated with the callback trigger (step 110).

As discussed above, in the preferred embodiment, the callback action is the establishment of a voice communication session between the user 16 and a person or entity specified by the callback trigger and having the power to grant access rights to the user 16 for the one or more redacted portions of the redacted electronic document associated with the callback trigger. The person or entity having the power to grant access rights to the user 16 for the one or more redacted portions may be specified in the callback trigger by a corresponding telephone number. The voice communication session may be established automatically upon detection of the triggering event. Alternatively, the user 16 may first be prompted to ask whether the user 16 desires to gain access rights to the one or more redacted portions. Then, if the user 16 answers “yes,” the voice communication session may be automatically established via the communication function 32 of the user device 14.

During the voice communication session, the user 16 gains access rights to the one or more redacted portions associated with the callback trigger by purchasing the access rights and/or performing a verification process. The verification process can be any process by which the person or entity having the power to grant the access rights verifies that the user 16 is a person that is entitled to receive the access rights. For example, an age verification process may be performed such that the access rights are granted if the user 16 is at least a predefined minimum age (e.g., 18 years old). As another example, an employee verification process may be performed such that the access rights are granted if the user 16 is an employee of a company for which the electronic document was created.

Note that when granting access rights to the user 16, the access rights may be granted to the entire redacted portion(s) associated with the callback trigger in an “all-or-nothing” scheme. Alternatively, access rights may be granted to subsets of the redacted portion(s) associated with the callback trigger. For example, the redacted portion(s) may be divided into a number of sub-units during redaction. Then, when granting access rights, the person or entity granting the access rights may select the entire redacted portion(s) such that the user 16 is granted access rights to the entire redacted portion(s) associated with the callback trigger or select one or more sub-units of the redacted portion(s) such that the user 16 is granted access to only those selected sub-units of the redacted portion(s) associated with the callback trigger. Alternatively, the selection of the one or more sub-units of the redacted portion(s) to which the user 16 is to be granted access rights may be done automatically based on characteristics of the user 16. For example, if the redacted electronic document is a document relating to a particular company and the redacted portion(s) include financial information about the company, then the user 16 may be granted access to the entire redacted portion(s) if the user 16 is the Chief Executive Officer (CEO) of the company or granted access to one or more predefined sub-units of the redacted portion(s) if the user 16 is a low-level employee.

After the callback action is performed and the user 16 has gained access rights to the one or more redacted portions associated with the callback trigger, the document reader 30 of the user device 14 sends a request to the document server 20 for the one or more redacted portions to which the user 16 has been granted access rights (step 112). In response, the document server 20 returns the one or more redacted portions to which the user 16 has been granted access to the user device 14 (step 114). Note that in an alternative embodiment, the document server 20 may return an updated redacted version of the electronic document in which the one or more redacted portions to which the user 16 has been granted access are no longer redacted. The document reader 30 of the user device 14 then provides access to an updated version of the redacted electronic document that includes the one or more redacted portions to which the user 16 has been granted access (step 116). At this point, the updated version of the redacted electronic document may still be a redacted version of the electronic document if there are additional redacted portions to which the user 16 has not been granted access or may be a complete version of the electronic document if the user 16 has been granted access to all of the redacted portions.

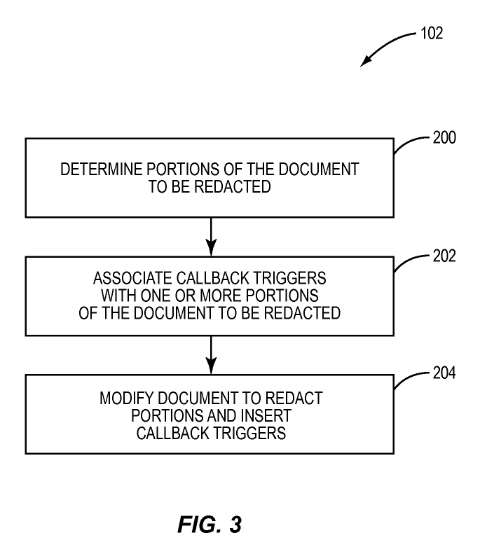

FIG. 3 is a flow chart illustrating the operation of the document server 20 to redact a requested electronic document and create callback triggers according to one embodiment of the present disclosure. More specifically, FIG. 3 is a more detailed illustration of step 102 of FIG. 2 according to one embodiment of the present disclosure. First, the redaction and trigger creation function 24 of the document server 20 determines one or more portions of the requested electronic document to be redacted (step 200). In this embodiment, since redaction is performed reactively in response to the document request, the redaction and trigger creation function 24 preferably determines the one or more portions of the electronic document to be redacted via an automatic process. For the automatic process, the redaction and trigger creation function 24 automatically redacts the electronic document based on one or more redaction criteria. Portions of the electronic document that satisfy the redaction criteria are identified as portions of the electronic document to be redacted. The one or more redaction criteria may be system-defined or user-defined redaction criteria. If user-defined, the one or more redaction criteria may be defined by any user having the right to control access to the electronic document such as, but not limited to, a creator of the electronic document, a representative of a creator of the electronic document, or a representative or employee associated with the central system 12.

The one or more redaction criteria may include generic redaction criteria that is the same for all electronic documents and/or document specific redaction criteria that is specific for the requested electronic document. Further, whether generic or document specific, the redaction criteria may include user-based redaction criteria, content-based redaction criteria, context-based redaction criteria, or a combination thereof. User-based redaction criteria are redaction criteria based on characteristics of the user 16 that requested the electronic document such as, but not limited to, demographics (e.g., age, gender, marital status, etc.), social network relationship between the user 16 and the creator of the electronic document (e.g., employee, boss, co-worker, corporate partner, friend, etc.), or the like. Thus, for user-based redaction criteria, the portions of the electronic document to be redacted vary based on the characteristics of the user 16 that has requested the electronic document.

Note that, preferably, the user-based redaction criteria are implemented in the following manner. First, sets of redaction criteria may be defined for each of a number of user types, or user groups. The user types are defined based on user characteristics such as demographics (e.g., age, gender, marital status, etc.). Then, when a consumer requests an electronic document, the characteristics of the consumer may be used to match the consumer to one or more of the defined user types. Then, the redaction criteria for the one or more matching user types are used to determine the portion(s) of the electronic document to be redacted.

Content-based redaction criteria are redaction criteria based on the content of the electronic document such that the portions of the electronic document to be redacted depends on the content of the electronic document. For example, the content-based redaction criteria may state that sections of the electronic document including specified keywords are to be redacted. As another example, a semantic analysis may be used to determine topics discussed in the electronic document, and the content-based redaction criteria may state that sections of the electronic document that discuss specified topics are to be redacted.

Context-based redaction criteria are redaction criteria based on the context of the user device 14 and/or the context of the user 16 at the time the document request is received from the user 16 such that the portions of the electronic document to be redacted depend on the context of the user device 14 and/or the context of the user 16. The context may include, for example, the current time of day when the request for the electronic document is made, the current date when the request for the electronic document is made, the current location of the user 16 when the request for the electronic document is made, or the like. Note that, preferably, the context-based redaction criteria are implemented in the following manner. First, sets of redaction criteria may be defined for each of a number of contexts. Then, when a consumer requests an electronic document, the contextual information (e.g., location of the consumer, time of receiving the document request, date on which the document request is received, or the like) may be used to match the context to one or more of the defined contexts. Then, the redaction criteria for the one or more matching contexts are used to determine the portion(s) of the electronic document to be redacted.

In addition to redacting the requested electronic document, the redaction and trigger creation function 24 of the document server 20 associates a callback trigger with each portion of the electronic document to be redacted (step 202). If there is more than one portion of the electronic document to be redacted, the same callback trigger may be associated with each of the portions to be redacted or different callback triggers may be associated with the different portions to be redacted. As discussed above, each callback trigger defines a triggering event and a callback action to be performed in order for the user 16 to gain access to one or more portions of the electronic document that have been redacted. The triggering event and/or callback action may be based on the redaction criteria resulting in the redaction of the associated portion(s) of the electronic document. More specifically, the redaction criteria may also specify the triggering event and/or callback action to be used for the callback trigger associated with portion(s) of the electronic document that are redacted as a result of the callback trigger. Thus, for example, the callback action for a portion of a corporate electronic document that is redacted for a corporate partner because the portion includes financial information may be to call the corporate partner's associated liaison (e.g., company CEO), whereas the callback action for a portion of the same electronic document that is redacted for an employee because the portion includes highly confidential information may be to call the employee's manager.

In this embodiment, the redaction and trigger creation function 24 of the document server 20 then modifies the requested electronic document to redact the one or more portions to be redacted and insert the callback trigger(s) (step 204). More specifically, in this embodiment, the one or more portions to be redacted are removed from the electronic document to create the redacted electronic document. In the redacted electronic document, each of the redacted portions is preferably replaced by an item representative of the redacted portion such as, but not limited to, a blacked-out region, an advertisement, an indicator that is indicative of the content of the redacted portion, a collapsible heading, a distorted version of the redacted portion, a place holder that provides a reason that the redacted portion is redacted, or the like. In addition, in this embodiment, one or more callback triggers associated with the redacted portions are inserted into the redacted electronic document. For example, the callback triggers may be stored in headers inside a digital file corresponding to the redacted electronic document. However, in an alternative embodiment, the callback triggers may be provided separately from the redacted electronic document to be used by the document reader 30 in association with the redacted electronic document. For instance, the callback triggers may be dynamically loaded callback triggers that are provided separately from the redacted electronic document and updated, or refreshed, over time. At this point, the redacted electronic document including the callback trigger(s) for the redacted portion(s) is sent to the user device 14 of the user 16 where the callback trigger(s) are used to enable the user 16 to gain access to the redacted portion(s) in the manner described above.

FIG. 3 describes an embodiment where the electronic document is redacted automatically based on one or more redaction criteria. However, in an alternative embodiment, the electronic document may be redacted via a manual process. For the manual process, a user manually interacts with the redaction and trigger creation function 24 to select the one or more portions of the electronic document to be redacted. In general, the user that selects the one or more portions of the electronic document is a person having the right to control access to the electronic document. More specifically, the user that selects the one or more portions of the electronic document to be redacted may be, for example, a creator of the electronic document, a representative of the creator of the electronic document, or a representative or employee associated with the central system 12.

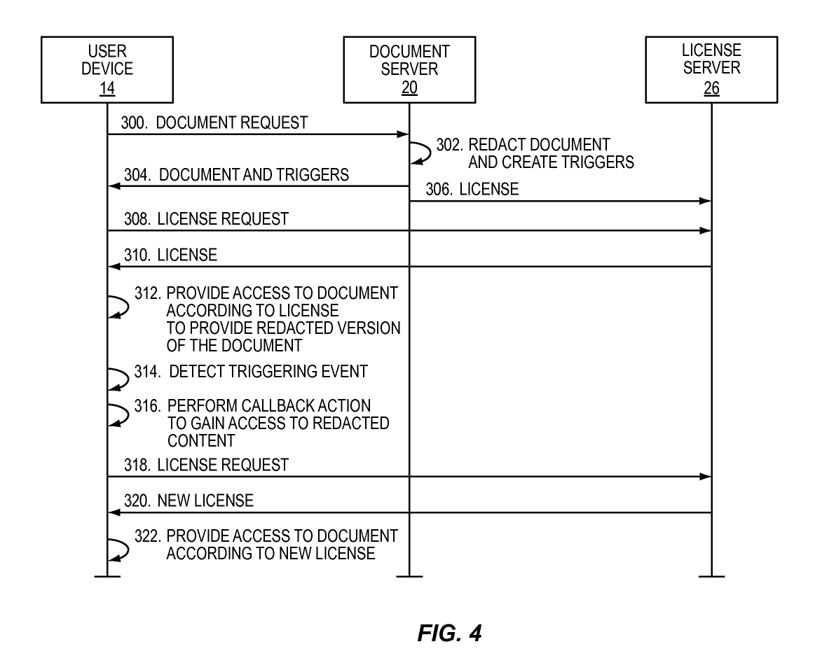

FIG. 4 illustrates the operation of the system 10 of FIG. 1 according to another embodiment of the present invention. First, the user device 14 sends a document request to the document server 20 of the central system 12 (step 300). The document request is a request for a specific electronic document. In response to receiving the document request, the document server 20 redacts the requested electronic document and creates one or more callback triggers for the redacted electronic document (step 302). In this embodiment, a licensing scheme is used to restrict access to the requested electronic document such that the user 16 is not permitted to access redacted portion(s) of the requested electronic document to thereby provide the redacted electronic document. Note, however, that Digital Rights Management (DRM) techniques other than licensing may be used.

In this embodiment, the redaction and trigger creation function 24 of the document server 20 creates the redacted electronic document by first determining one or more portions of the requested electronic document to be redacted. As discussed above, since in this embodiment redaction is performed reactively in response to receiving the document request, the redaction and trigger creation function 24 preferably determines the one or more portions of the electronic document to be redacted via an automatic process. For the automatic process, the redaction and trigger creation function 24 automatically redacts the electronic document based on one or more redaction criteria. Portions of the electronic document that satisfy the redaction criteria are identified as portions of the electronic document to be redacted. The one or more redaction criteria may be system-defined or user-defined redaction criteria. If user-defined, the one or more redaction criteria may be defined by any user having the right to control access to the electronic document such as, but not limited to, a creator of the electronic document, a representative of a creator of the electronic document, or a representative or employee associated with the central system 12. Further, as discussed above, the one or more redaction criteria may include generic redaction criteria that is the same for all electronic documents and/or document specific redaction criteria that is specific for the requested electronic document. Further, whether generic or document specific, the redaction criteria may include user-based redaction criteria, content-based redaction criteria, context-based redaction criteria, or a combination thereof.

In addition, the redaction and trigger creation function 24 of the document server 20 associates a callback trigger with each redacted portion of the redacted electronic document. Each callback trigger is associated with one or more of the redacted portions. More specifically, each callback trigger defines a triggering event and a callback action. The triggering event is defined as the occurrence of a specified user action at a specified location within the redacted electronic document. The location for the triggering event for a callback trigger corresponds to a location of the corresponding redacted portion within the redacted electronic document. The user action may be any user action such as, but not limited to, user selection, scrolling, dwelling, gazing, or the like. For example, the triggering event may be user selection of an item representing the associated redacted portion of the redacted electronic document, scrolling past the location of the associated redacted portion of the redacted electronic document, dwelling at the location of the associated redacted portion of the redacted electronic document for more than a predefined amount of time, gazing upon the location of the associated redacted portion of the redacted electronic document, or the like. The callback action is preferably establishment of a voice communication session between the user 16 and a specified person or entity having the power to grant access rights to the associated redacted portion of the redacted electronic document. However, in an alternative embodiment, the callback action may be contacting an e-commerce service associated with or included within the central system 12 to perform an e-commerce transaction to gain access to the redacted portion of the redacted electronic document.

Next, the document server 20 of the central system 12 returns the requested electronic document and the one or more callback triggers associated with the one or more redacted portions of the redacted electronic document to the user device 14 (step 304). In addition, the document server 20 generates and sends a license for the requested electronic document for the user 16 to the license server 26 of the central system 12 (step 306). The license includes information that will enable the document reader 30 of the user device 14 of the user 16 to have limited access to the electronic document. Access is limited such that the user 16 does not have access to the one or more redacted portions to thereby provide the redacted electronic document. In addition, the license may have restrictions based on criteria such as location, time, date, or the like. For example, the license may be generated such that the user 16 will have full access to the electronic document for a limited period of time or while the user 16 is at a particular location. Once the limited period of time has expired or the user 16 has left the particular location, the license controls access to the electronic document such that the user 16 has access to the redacted electronic document.

Since a licensing scheme is used, the document reader 30 obtains the license to the electronic document granted to the user 16. In this embodiment, the document reader 30 obtains the license to the electronic document granted to the user 16 by sending a license request to the license server 26 of the central system 12 (step 308). In response, the license server 26 returns the license to the electronic document that has been granted to the user 16 (step 310). In an alternative embodiment, the document server 20 may provide the license to the user device 14 along with the electronic document in step 304.

The document reader 30 of the user device 14 then provides access to the electronic document according to the license to thereby provide the redacted electronic document (step 312). While the user 16 is consuming, or reading, the redacted electronic document, the document reader 30 detects an occurrence of the triggering event for one of the callback triggers (step 314). In response to detecting the triggering event, the document reader 30 performs the callback action for the callback trigger in order for the user 16 to gain access rights to the one or more redacted portions associated with the callback trigger (step 316).

As discussed above, in the preferred embodiment, the callback action is the establishment of a voice communication session between the user 16 and a person or entity specified by the callback trigger and having the power to grant access rights to the user 16 for the one or more redacted portions of the redacted electronic document associated with the callback trigger. The person or entity having the power to grant access rights to the user 16 for the one or more redacted portions may be specified in the callback trigger by a corresponding telephone number. The voice communication session may be established automatically upon detection of the triggering event. Alternatively, the user 16 may first be prompted to ask whether the user 16 desires to gain access rights to the one or more redacted portions. Then, if the user 16 answers “yes,” the voice communication session may be automatically established via the communication function 32 of the user device 14.

During the voice communication session, the user 16 gains access rights to the one or more redacted portions associated with the callback trigger by purchasing the access rights and/or performing a verification process. The verification process can be any process by which the person or entity having the power to grant the access rights verifies that the user 16 is a person that is entitled to receive the access rights. For example, an age verification process may be performed such that the access rights are granted if the user 16 is at least a predefined minimum age (e.g., 18 years old). As another example, an employee verification process may be performed such that the access rights are granted if the user 16 is an employee of a company for which the electronic document was created.

Note that when granting access rights to the user 16, the access rights may be granted to the entire redacted portion(s) associated with the callback trigger in an “all-or-nothing” scheme. Alternatively, access rights may be granted to subsets of the redacted portion(s) associated with the callback trigger. For example, the redacted portion(s) may be divided into a number of sub-units during redaction. Then, when granting access rights, the person or entity granting the access rights may select the entire redacted portion(s) such that the user 16 is granted access rights to the entire redacted portion(s) associated with the callback trigger or select one or more sub-units of the redacted portion(s) such that the user 16 is granted access to only those selected sub-units of the redacted portion(s) associated with the callback trigger.

Once the callback action is complete, a new license to the electronic document for the user 16 is published to the license server 26. The manner in which the new license is published to the license server 26 may vary depending on the particular implementation. For example, once the user 16 has purchased access rights or been verified, the document server 20 may be notified of the redacted portions to which the user 16 has been granted access rights. In response, the document server 20 may generate the new license for the user 16 and publish the new license to the license server 26. The new license may include additional restrictions based on location, time, date, or the like. For example, the user 16 may be granted access to the redacted portion(s) for a limited amount of time (e.g., one month) after which time the user 16 will no longer be able to access the redacted portion(s). Similarly, access to the redacted portion(s) may be limited to a particular location or geographic area, limited to a particular date or range of dates, or the like.

Next, the document reader 30 of the user device 14 obtains the new license to the electronic document for the user 16 from the license server 26. More specifically, in this embodiment, the document reader 30 sends a license request to the license server 26 (step 318). In response, the license server 26 returns a new license to the electronic document for the user 16 to the user device 14 (step 320). In an alternative embodiment, the new license may be automatically pushed to the user device 14 once the user 16 has purchased or otherwise acquired access rights to the one or more redacted portions of the redacted electronic document. The document reader 30 of the user device 14 then provides access to the electronic document according to the new license such that the user 16 has access to the one or more redacted portions to which the user 16 has been granted access rights (step 322).

It should be noted that FIGS. 2-4 describe embodiments where redaction is performed reactively in response to receiving a document request. In an alternative embodiment, redaction may be performed proactively prior to receiving a document request. More specifically, either a manual or automatic process may be used to define one or more redacted versions of the electronic document. The redacted portion(s) of the different redacted versions may vary as a function of user characteristics such as demographics, social network relationship to a creator of the electronic document, or the like. As such, the redacted version provided to a particular consumer may be a redacted version defined for users having user characteristics like those of the consumer. In addition or alternatively, the redacted portion(s) may vary as a function of context such as location of the consumer at the time the consumer requests the electronic document, a time of day at which the consumer requests the electronic document, a date on which the consumer requests the electronic document, or the like. As such, the redacted version provided to a consumer may be a redacted version defined for the current location of the consumer, the current time of day, the current date, or the like.

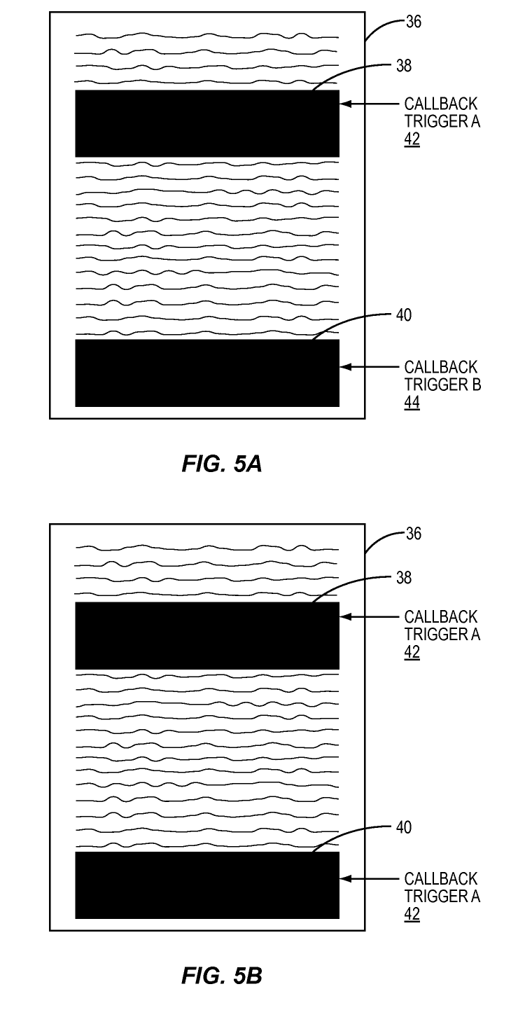

FIGS. 5A and 5B graphically illustrate a redacted electronic document 36 according to one exemplary embodiment of the present disclosure. The redacted electronic document 36 includes blacked-out regions 38 and 40 replacing corresponding redacted portions of the redacted electronic document 36. In the embodiment where the redacted electronic document 36 does not include the redacted portions, the blacked-out regions 38 and 40 are inserted into the redacted electronic document 36 in place of the corresponding redacted portions of the redacted electronic document 36. In the embodiment where access to the redacted portions is restricted via a DRM technique, the blacked-out regions 38 and 40 may be shown in place of the corresponding redacted portions of the redacted electronic document 36 as a result of the DRM technique.

In the embodiment of FIG. 5A, different callback triggers 42 and 44 are associated with the redacted portions of the redacted electronic document 36. As shown, a first callback trigger 42 (callback trigger A) is associated with the redacted portion of the redacted electronic document 36 replaced by the blacked-out region 38. The first callback trigger 42 defines a triggering event, where the triggering event is the occurrence of a specified user action at the location in the redacted electronic document 36 corresponding to the redacted portion replaced by the blacked-out region 38. The user action may be, for example, selecting (e.g., clicking on) the blacked-out region 38, scrolling past the blacked-out region 38, dwelling on or near the blacked-out region 38 for more than a predefined amount of time, gazing at the blacked-out region 38, or the like. Upon detecting the occurrence of the triggering event, a specified callback action is performed in order to gain access to the redacted portion replaced by the blacked-out region 38.

In a similar manner, a second callback trigger 44 (callback trigger B) is associated with the redacted portion of the redacted electronic document 36 replaced by the blacked-out region 40. The second callback trigger 44 defines a triggering event, where the triggering event is the occurrence of a specified user action at the location in the redacted electronic document 36 corresponding to the redacted portion replaced by the blacked-out region 40. Upon detecting the occurrence of the triggering event, a specified callback action is performed in order to gain access to the redacted portion replaced by the blacked-out region 40.

In FIG. 5B, the same callback trigger 42 (callback trigger A) is associated with both of the redacted portions replaced by the blacked-out regions 38 and 40. In this embodiment, the callback trigger 42 defines a triggering event, where the triggering event is the occurrence of a specified user action at the location in the redacted electronic document 36 corresponding to either the redacted portion replaced by the blacked-out region 38 or the redacted portion replaced by the blacked-out region 40. Upon detecting the occurrence of the triggering event, a specified callback action is performed in order to gain access to the redacted portions replaced by the blacked-out regions 38 and 40.

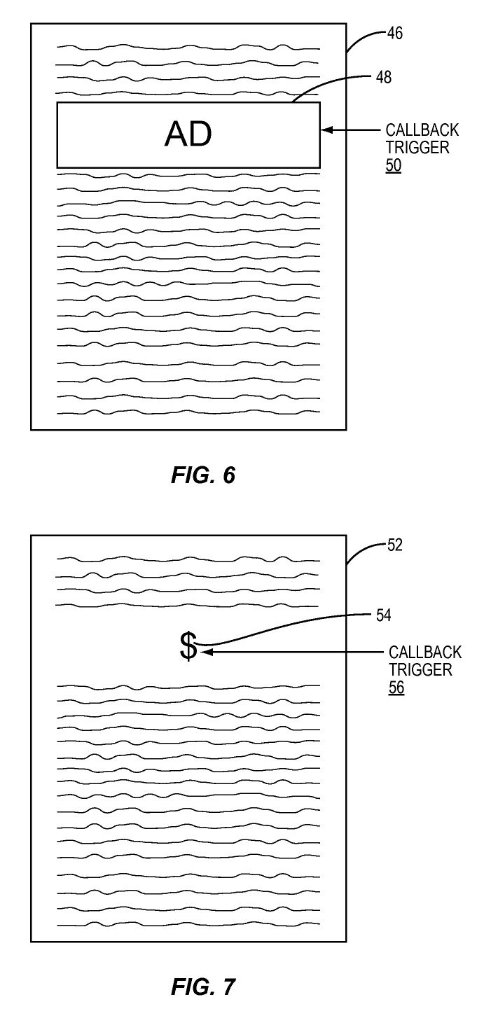

FIG. 6 graphically illustrates a redacted electronic document 46 according to another exemplary embodiment of the present disclosure. In this embodiment, rather than being replaced with a blacked-out region, a redacted portion of the redacted electronic document 46 is replaced with an advertisement 48 having an associated callback trigger 50 for gaining access to the redacted portion. The advertisement 48 may be static. Alternatively, the advertisement 48 may be dynamic (e.g., updated periodically or each time the redacted electronic document 46 is opened by the user 16).

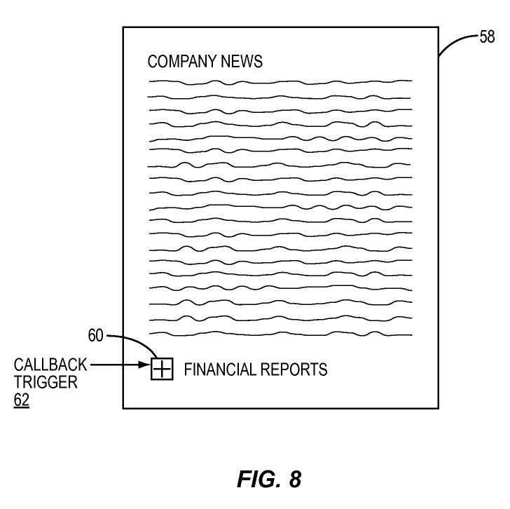

FIG. 7 graphically illustrates a redacted electronic document 52 according to another exemplary embodiment of the present disclosure. In this embodiment, rather than being replaced with a blacked-out region or an advertisement, a redacted portion of the redacted electronic document 52 is replaced with an indicator 54 having an associated callback trigger 56 for gaining access to the redacted portion. The indicator 54 is indicative both the location of the redacted portion within the redacted electronic document 52 as well as the content of the redacted portion. In this example, the indicator 54 is a dollar symbol that indicates that the redacted portion includes financial information.

FIG. 8 graphically illustrates a redacted electronic document 58 according to another exemplary embodiment of the present disclosure. In this embodiment, a redacted portion of the redacted electronic document 58 is replaced with a collapsible heading 60 having an associated callback trigger 62 for gaining access to the redacted portion. Upon selecting the collapsible heading 60, the callback action is performed in order for the user 16 to gain access to the redacted portion.

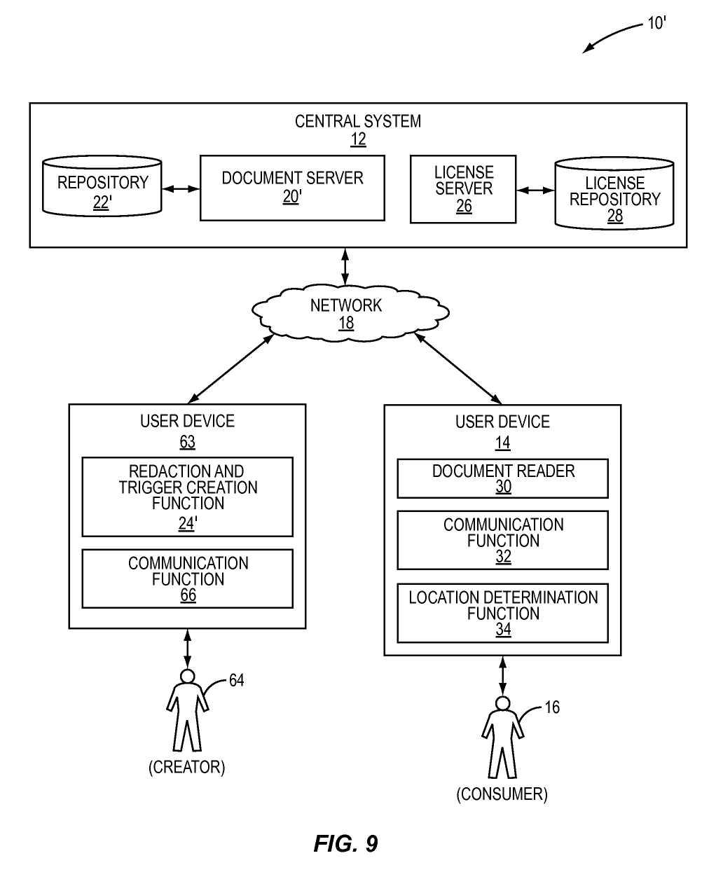

FIG. 9 illustrates the system 10′ according to another embodiment of the present disclosure. This embodiment is similar to that of FIG. 1. However, in this embodiment, the redaction and trigger creation function 24′ is implemented on a user device 63 associated with a user 64 that is a creator of an electronic document or a representative of the creator of the electronic document rather than implemented on the central system 12. The user device 63 may be any type of user device such as, but not limited to, a personal computer. The user device 63 includes the redaction and trigger creation function 24′ and a communication function 66. The redaction and trigger creation function 24′ may be implemented in software, hardware, or a combination thereof. In general, the redaction and trigger creation function 24′ operates to redact one or more electronic documents at the user device 63 and provide corresponding data to the central system 12 for distribution. The communication function 66 is implemented in hardware or a combination of software and hardware. In general, the communication function 66 includes a hardware component for communicatively coupling the user device 63 to the network 18 via a wired connection (e.g., Ethernet connection) or wireless connection (e.g., IEEE 802.11 local wireless connection or 3G or 4G wireless cellular connection).

Before proceeding, it should be noted that in the system 10′ of FIG. 9 may be further modified to enable peer-to-peer (P2P) distribution of electronic documents. For example, the document server 20′ may also be implemented on the user device 63 such that the user device 63 is further enabled to distribute redacted electronic documents to other user devices such as the user device 14.

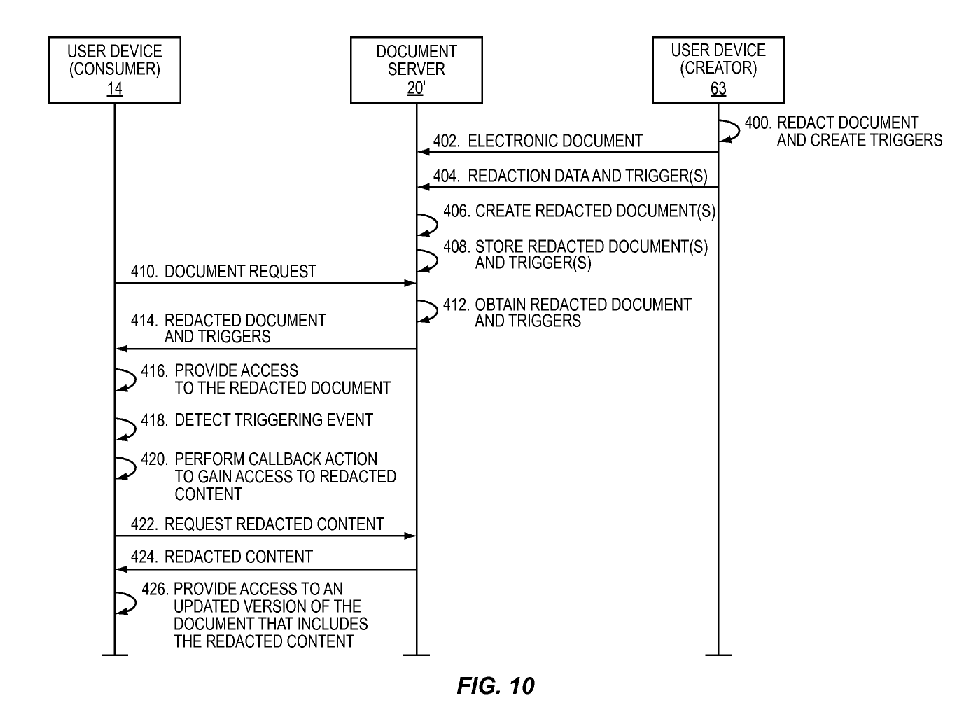

FIG. 10 illustrates the operation of the system 10′ of FIG. 9 according to one embodiment of the present disclosure. First, the redaction and trigger creation function 24′ of the user device 63 operates to redact an electronic document and create a trigger(s) associated with the redacted portion(s) (step 400). In this embodiment, one or more redacted versions of the electronic document are created. For example, as discussed below, different redacted versions may be created for different types of requesting users or different contexts.

The redaction and trigger creation function 24′ redacts the electronic document via a manual process or an automatic or programmatic process. More specifically, the redaction and trigger creation function 24′ of the user device 63 determines one or more portions of the electronic document to be redacted. The redaction and trigger creation function 24′ determines the one or more portions of the electronic document to be redacted via either a manual process or an automatic or programmatic process. For the manual process, the user 64 manually interacts with the redaction and trigger creation function 24′ to select the one or more portions of the electronic document to be redacted. The user 64 may select the one or more portions of the electronic document to be redacted for a single redacted version of the electronic document. Alternatively, if multiple redacted versions of the electronic document are desired, the user 64 selects one or more portions of the electronic document to be redacted for each redacted version of the electronic document. Different redacted versions of the electronic document, or different redacted electronic documents, may be desired for different types of requesting users. Thus, for example, the user 64 may select one or more portions to be redacted for a redacted version of the electronic document for each of one or more requesting user types. The requesting user types may be defined using user characteristics such as demographics, social network relationship to the user 64, or the like. In a similar manner, different redacted electronic documents may be defined for requesting users in different contexts (e.g., different locations, different times of the day, different dates, or the like).

For the automatic process, the redaction and trigger creation function 24′ automatically or programmatically redacts the electronic document based on one or more redaction criteria. Portions of the electronic document that satisfy the redaction criteria are identified as portions of the electronic document to be redacted. The one or more redaction criteria may be system-defined or user-defined redaction criteria. If user-defined, the one or more redaction criteria are defined by the user 64. The one or more redaction criteria may be generic redaction criteria that is the same for all electronic documents created by the user 64 or document specific redaction criteria that is specific for the electronic document. Further, as discussed above, whether generic or document specific, the redaction criteria may include user-based redaction criteria, content-based redaction criteria, or context-based redaction criteria. Note that the user-based redaction criteria and/or the context-based redaction criteria may result in multiple redacted versions of the electronic document being defined for different user types and/or different contexts.

In addition to determining the portions to the electronic document to be redacted, the redaction and trigger creation function 24′ associates a callback trigger with each of the portions of the electronic document to be redacted. If there is more than one portion of the electronic document to be redacted, the same callback trigger may be associated with each of the portions to be redacted or different callback triggers may be associated with the different portions to be redacted. As discussed above, each callback trigger defines a triggering event and a callback action to be performed in order for a requesting user, such as the user 16, to gain access to one or more portions of the electronic document that have been redacted. In this embodiment, the user 64 may define the callback actions for the triggers. For example, the user 64 may specify that the callback action for the triggers is to call the user 64 or a representative of the user 64 in order to gain access rights to the redacted portions.

In this embodiment, the redaction and trigger creation function 24′ sends the electronic document as well as redaction data and trigger(s) for each redacted version of the electronic document to the document server 20′ (steps 402 and 404). The redaction data identifies the one or more portions of the electronic document to be redacted for each redacted version of the electronic document (i.e., defines the redacted portion(s) for each redacted electronic document). The document server 20′ then uses the redaction data to create the redacted electronic document(s) (step 406). In this embodiment, each redacted electronic document is created by removing the one or more portions to be redacted for that redacted version from the electronic document. In addition, each of the redacted portions may be replaced with a blacked-out region, an advertisement, an indicator that is indicative of the content of the redacted portion, a collapsible heading, a distorted version of the redacted portion, a place holder that provides a reason that the redacted portion is redacted, or the like. The document server 20′ stores the redacted electronic document(s) and trigger(s) in the repository 22′ (step 408). Note that the trigger(s) may be inserted into the redacted electronic document(s) or may be maintained separate from the redacted electronic document(s).

Subsequently, the document server 20′ receives a request for the electronic document from the user device 14 of the user 16 (step 410). In response to the request, the document server 20′ obtains the appropriate redacted electronic document and callback trigger(s) for the requested electronic document (step 412). If there is only a single redacted electronic document for the requested electronic document, then that redacted electronic document and the callback trigger(s) for the redacted electronic document are obtained. However, if there are multiple redacted electronic documents (i.e., multiple redacted versions) for the requested electronic document, then the document server 20′ determines which of the redacted electronic documents is to be returned to the user device 14 of the user 16. As discussed above, different redacted electronic documents may be defined for each of a number of requesting user types and/or contexts. As such, based on characteristics of the user 16 and/or the context of the document request (e.g., the location of the user 16, the time of day at which the document request is received, the date on which the document request is received), the document server 20′ selects the matching redacted electronic document as the redacted electronic document to be returned to the user device 14 of the user 16. Alternatively, the document server 20′ may query the user 64 such that the user 64 is enabled to select which redacted version is to be sent to the user 16. The document server 20′ then returns the redacted electronic document and callback trigger(s) to the user device 14 of the user 16 (step 414).

The document reader 30 of the user device 14 then provides access to the redacted electronic document to the user 16 (step 416). While the user 16 is consuming, or reading, the redacted electronic document, the document reader 30 detects an occurrence of the triggering event for one of the callback triggers (step 418). In response to detecting the triggering event, the document reader 30 performs the callback action for the callback trigger in order for the user 16 to gain access rights to the one or more redacted portions associated with the callback trigger (step 420).

As discussed above, in the preferred embodiment, the callback action is the establishment of a voice communication session between the user 16 and a person or entity specified by the callback trigger and having the power to grant access rights to the user 16 for the one or more redacted portions of the redacted electronic document associated with the callback trigger. The person or entity having the power to grant access rights may be specified by a corresponding telephone number. Note, however, that the user 16 may be unaware of the telephone number. In this embodiment, the callback action is preferably calling the user 64, but is not limited thereto. The voice communication session may be established automatically upon detection of the triggering event. Alternatively, the user 16 may first be prompted to ask whether the user 16 desires to gain access rights to the one or more redacted portions. Then, if the user 16 answers “yes,” the voice communication session may be automatically established via the communication function 32 of the user device 14.

During the voice communication session, the user 16 gains access rights to the one or more redacted portions associated with the callback trigger by purchasing the access rights and/or performing a verification process. The verification process can be any process by which the person or entity having the power to grant the access rights verifies that the user 16 is a person that is entitled to receive the access rights. For example, an age verification process may be performed such that the access rights are granted if the user 16 is at least a predefined minimum age (e.g., 18 years old). As another example, an employee verification process may be performed such that the access rights are granted if the user 16 is an employee of a company for which the electronic document was created.

Note that when granting access rights to the user 16, the access rights may be granted to the entire redacted portion(s) associated with the callback trigger in an “all-or-nothing” scheme. Alternatively, access rights may be granted to subsets of the redacted portion(s) associated with the callback trigger. For example, the redacted portion(s) may be divided into a number of sub-units during redaction. Then, when granting access rights, the redaction and callback trigger creation function 24′ may enable the user 64 to select the entire redacted portion(s) such that the user 16 is granted access rights to the entire redacted portion(s) associated with the callback trigger or select one or more sub-units of the redacted portion(s) such that the user 16 is granted access to only those selected sub-units of the redacted portion(s) associated with the callback trigger.

After the callback action is performed and the user 16 has gained access rights to the one or more redacted portions associated with the callback trigger, the document reader 30 of the user device 14 sends a request to the document server 20′ for the one or more redacted portions to which the user 16 has been granted access rights (step 422). Note that, at this point, the document server 20′ has been notified of the access rights granted to the user 16. In response, the document server 20′ returns the one or more redacted portions to which the user 16 has been granted access to the user device 14 (step 424). In an alternative embodiment, the document server 20′ may return an updated redacted version of the electronic document in which the one or more redacted portions to which the user 16 has been granted access are no longer redacted. The document reader 30 of the user device 14 then provides access to an updated version of the redacted electronic document that includes the one or more portions to which the user 16 has been granted access (step 426). At this point, the updated version of the redacted electronic document may still be a redacted version of the electronic document if there are additional redacted portions to which the user 16 has not been granted access or may be a complete version of the electronic document if the user 16 has been granted access to all of the redacted portions.

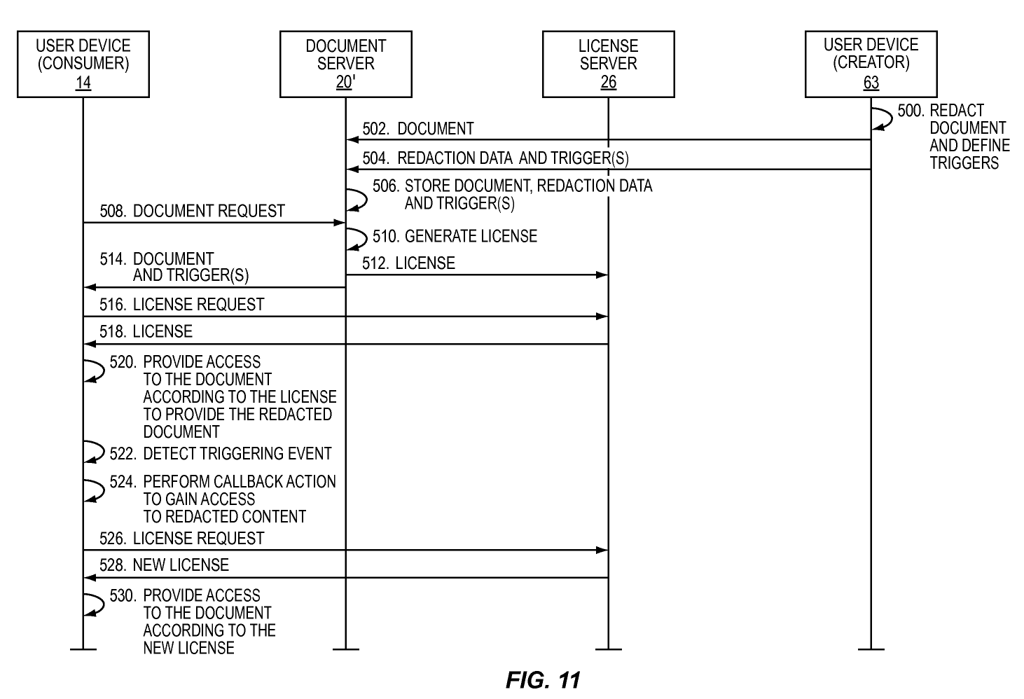

FIG. 11 illustrates the operation of the system 10′ of FIG. 9 according to another embodiment of the present disclosure. First, the redaction and trigger creation function 24′ of the user device 63 operates to redact an electronic document and create a trigger(s) associated with the redacted portion(s) and then sends the electronic document, redaction data, and trigger(s) to the document server 20′ (steps 500-504). Steps 500-504 are the same as steps 400-404 discussed above with respect to FIG. 10. The redaction data identifies the one or more portions of the electronic document to be redacted for each redacted version of the electronic document (i.e., each redacted electronic document). The document server 20′ then stores the electronic document, redaction data, and trigger(s) in the repository 22′ (step 506).

Subsequently, the document server 20′ receives a request for the electronic document form the user device 14 of the user 16 (step 508). In response, the document server 20′ uses the redaction data to generate a license to the electronic document for the user 16 (step 510). The license is generated based on the redaction data such that the license restricts access to the electronic document in order to provide the appropriate redacted version of the electronic document, or redacted electronic document. If the redaction data identifies the redacted portions for multiple redacted electronic documents (i.e., multiple redacted versions of the electronic document), then the document server 20′ determines which of the redacted electronic documents is appropriate for the user 16. As discussed above, different redacted electronic documents may be defined for each of a number of requesting user types and/or contexts. As such, based on characteristics of the user 16 and/or the context of the document request (e.g., the location of the user 16, the time of day at which the document request is received, the date on which the document request is received), the document server 20′ identifies the redacted electronic document that is appropriate for the user 16 and generates the license for the user 16 accordingly. Alternatively, the document server 20′ may query the user 64 such that the user 64 is enabled to select which redacted version is to be sent to the user 16. The document server 20′ then provides the license to the license server 26 for storage in the license repository 28 (step 512). In addition, the license may have restrictions based on criteria such as location, time, date, or the like. For example, the license may be generated such that the user 16 will have full access to the electronic document for a limited period of time or while the user 16 is at a particular location. Once the limited period of time has expired or the user 16 has left the particular location, the license controls access to the electronic document such that the user 16 has access to the redacted electronic document.

The document server 20′ then returns the electronic document and the callback trigger(s) to the user device 14 of the user 16 (step 514). Note that the callback trigger(s) may be inserted into the electronic document, provided separately from the electronic document, or alternatively included in the license generated for the user 16. In this embodiment, the electronic document is protected using a DRM technique such that the electronic document is not accessible without the license granted to the user 16. As such, the document reader 30 of the user device 14 sends a license request to the license server 26 (step 516). In response, the license server 26 returns the license generated by the document server 20′ for the user 16 to the document reader 30 of the user device 14 (step 518). Alternatively, the license may be sent to the user device 14 in step 514 along with the electronic document and trigger(s).

The document reader 30 of the user device 14 then provides access to the electronic document according to the license to thereby provide the redacted electronic document to the user 16 (step 520). While the user 16 is consuming, or reading, the redacted electronic document, the document reader 30 detects an occurrence of the triggering event for one of the callback triggers (step 522). In response to detecting the triggering event, the document reader 30 performs the callback action for the callback trigger in order for the user 16 to gain access rights to the one or more redacted portions associated with the callback trigger (step 524).

As discussed above, in the preferred embodiment, the callback action is the establishment of a voice communication session between the user 16 and a person or entity specified by the callback trigger and having the power to grant access rights to the user 16 for the one or more redacted portions of the redacted electronic document associated with the callback trigger. The person or entity having the power to grant access rights may be specified by a corresponding telephone number. In this embodiment, the callback action is preferably calling the user 64, but is not limited thereto. The voice communication session may be established automatically upon detection of the triggering event. Alternatively, the user 16 may first be prompted to ask whether the user 16 desires to gain access rights to the one or more redacted portions. Then, if the user 16 answers “yes,” the voice communication session may be automatically established via the communication function 32 of the user device 14. During the voice communication session, the user 16 gains access rights to the one or more redacted portions associated with the callback trigger by purchasing the access rights and/or performing a verification process. The verification process can be any process by which the person or entity having the power to grant the access rights verifies that the user 16 is a person that is entitled to receive the access rights. For example, an age verification process may be performed such that the access rights are granted if the user 16 is at least a predefined minimum age (e.g., 18 years old). As another example, an employee verification process may be performed such that the access rights are granted if the user 16 is an employee of a company for which the electronic document was created.

Again, note that when granting access rights to the user 16, the access rights may be granted to the entire redacted portion(s) associated with the callback trigger in an “all-or-nothing” scheme. Alternatively, access rights may be granted to subsets of the redacted portion(s) associated with the callback trigger. For example, the redacted portion(s) may be divided into a number of sub-units during redaction. Then, when granting access rights, the redaction and callback trigger creation function 24′ may enable the user 64 to select the entire redacted portion(s) such that the user 16 is granted access rights to the entire redacted portion(s) associated with the callback trigger or select one or more sub-units of the redacted portion(s) such that the user 16 is granted access to only those selected sub-units of the redacted portion(s) associated with the callback trigger.

After the callback action is performed and the user 16 has gained access rights to the one or more redacted portions associated with the callback trigger, the document reader 30 of the user device 14 sends a license request to the license server 26 (step 526). Note that, at this point, the document server 20′ has been notified of the granted access rights, generated a new license for the user 16, and provided the new license to the license server 26. The new license may include additional restrictions based on location, time, date, or the like. For example, the user 16 may be granted access to the redacted portion(s) for a limited amount of time (e.g., one month) after which time the user 16 will no longer be able to access the redacted portion(s). Similarly, access to the redacted portion(s) may be limited to a particular location or geographic area, limited to a particular date or range of dates, or the like.

In response, the license server 26 returns to the new license to the document reader 30 of the user device 14 (step 528). Alternatively, the new license may be automatically pushed to the user device 14 once the user 16 has been granted access rights to the redacted portion(s) as a result of performing the callback action. The document reader 30 of the user device 14 then provides access to the electronic document according to the new license (step 530). As a result of the new license, the user 16 has access to the previously redacted portion(s) to which the user 16 has gain access rights through performance of the callback action.

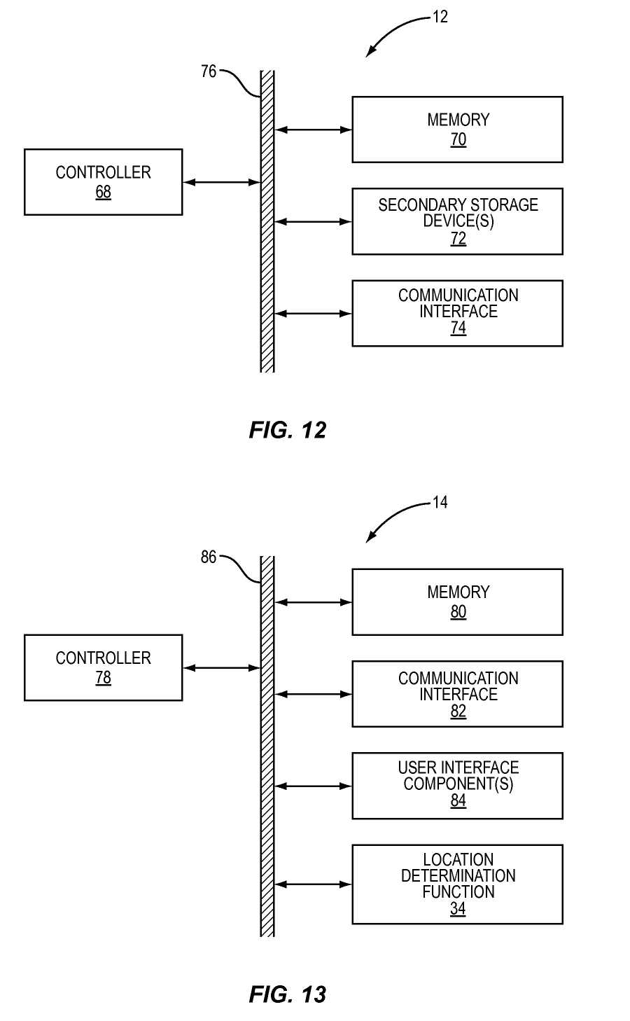

FIG. 12 is a block diagram of the central system 12 of FIGS. 1 and 9 according to one embodiment of the present disclosure. As illustrated, the central system 12 includes a controller 68 connected to memory 70, one or more secondary storage devices 72, and a communication interface 74 by a bus 76 or similar mechanism. The controller 68 is a microprocessor, digital Application Specific Integrated Circuit (ASIC), Field Programmable Gate Array (FPGA), or the like. In this embodiment, the controller 68 is a microprocessor, and the document server 20/20′ and the license server 26 are implemented in software and stored in the memory 70 for execution by the controller 68. Further, depending on the particular embodiment, the repository 22/22′ and the license repository 28 are stored in the one or more secondary storage devices 72. The secondary storage devices 72 are digital data storage devices such as, for example, one or more hard disk drives. The communication interface 74 is a wired or wireless communication interface that communicatively couples the central system 12 to the network 18 (FIGS. 1 and 9). For example, the communication interface 74 may be an Ethernet interface, local wireless interface such as a wireless interface operating according to one of the suite of IEEE 802.11 standards, or the like.

FIG. 13 is a block diagram of the user device 14 of FIGS. 1 and 9 according to one embodiment of the present disclosure. As illustrated, the user device 14 includes a controller 78 connected to memory 80, a communication interface 82, one or more user interface components 84, and the location determination function 34 by a bus 86 or similar mechanism. The controller 78 is a microprocessor, digital ASIC, FPGA, or the like. In this embodiment, the controller 78 is a microprocessor, and the document reader 30 (FIGS. 1 and 9) is implemented in software and stored in the memory 80 for execution by the controller 78. The communication interface 82 is a wired or wireless communication interface that communicatively couples the user device 14 to the network 18 (FIGS. 1 and 9). For example, the communication interface 82 may be an Ethernet interface, local wireless interface such as a wireless interface operating according to one of the suite of IEEE 802.11 standards, a mobile communications interface such as a cellular telecommunications interface, or the like. The communication function 32 (FIGS. 1 and 9) may be implemented as software stored in the memory 80 and executed by the controller 78 and/or as a component of the communication interface 82. The one or more user interface components 84 include, for example, a touchscreen, a display, one or more user input components (e.g., a keypad), a speaker, or the like, or any combination thereof. In this embodiment, the location determination function 34 is implemented as a hardware component such as, for example, a GPS receiver.

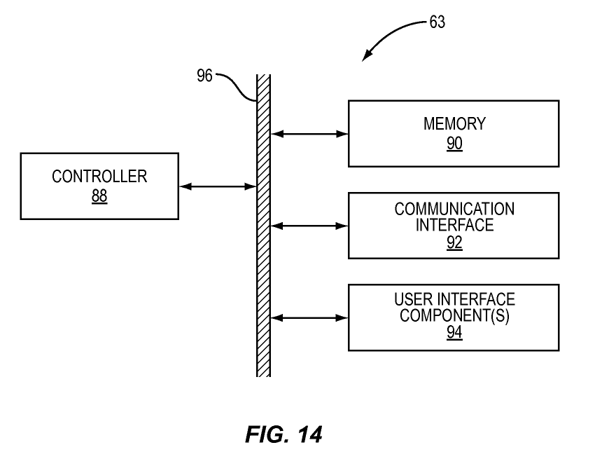

FIG. 14 is a block diagram of the user device 63 of FIG. 9 according to one embodiment of the present disclosure. As illustrated, the user device 63 includes a controller 88 connected to memory 90, a communication interface 92, and one or more user interface components 94 by a bus 96 or similar mechanism. The controller 88 is a microprocessor, digital ASIC, FPGA, or the like. In this embodiment, the controller 88 is a microprocessor, and the redaction and trigger creation function 24′ (FIG. 9) is implemented in software and stored in the memory 90 for execution by the controller 88. The communication interface 92 is a wired or wireless communication interface that communicatively couples the user device 63 to the network 18 (FIG. 9). For example, the communication interface 92 may be an Ethernet interface, local wireless interface such as a wireless interface operating according to one of the suite of IEEE 802.11 standards, a mobile communications interface such as a cellular telecommunications interface, or the like. The communication function 66 (FIG. 9) may be implemented software stored in the memory 90 and executed by the controller 88 and/or as a component of the communication interface 92. The one or more user interface components 94 include, for example, a touchscreen, a display, one or more user input components (e.g., a keypad), a speaker, or the like, or any combination thereof.

Those skilled in the art will recognize improvements and modifications to the embodiments of the present invention. All such improvements and modifications are considered within the scope of the concepts disclosed herein and the claims that follow.

What is claimed is:

1. A method of operation of a user device comprising:
obtaining a redacted electronic document having a redacted portion;
providing access to the redacted electronic document to a user at the user device;
detecting a triggering event defined by a callback trigger associated with the redacted portion of the redacted electronic document during consumption of the redacted electronic document by the user;
performing a callback action defined by the callback trigger in response to detecting the triggering event such that the user is granted access rights to the redacted portion of the redacted electronic document; and
providing access to the redacted portion of the redacted electronic document after the user is granted access rights to the redacted portion of the redacted electronic document.

2. The method of claim 1 wherein the user device has voice communication capabilities, and the callback action is automatically establishing, via the user device, a voice communication session between the user at the user device and one of a group consisting of: a person having power to grant access rights for the redacted portion to the user and an entity having power to grant access rights for the redacted portion to the user.

3. The method of claim 1 wherein the redacted electronic document does not include the redacted portion.

4. The method of claim 3 further comprising obtaining the redacted portion after the user is granted access rights to the redacted portion of the redacted electronic document.

5. The method of claim 1 wherein the redacted electronic document is a redacted version of an electronic document, and obtaining the redacted electronic document comprises:
obtaining the electronic document; and
obtaining a license to the electronic document that prevents access to the redacted portion to thereby provide the redacted electronic document.

6. The method of claim 5 further comprising obtaining a new license to the electronic document for the user that permits access to the redacted portion after the user has been granted access rights to the redacted portion.

7. The method of claim 1 wherein the redacted portion is replaced within the redacted electronic document by one of a group consisting of: a blacked-out region, an advertisement, an indicator that is indicative of content of the redacted portion, a collapsible heading, a distorted version of the redacted portion, and a place holder that provides a reason that the redacted portion is redacted.

8. The method of claim 1 wherein the triggering event is an occurrence of a specified user action at a location within the redacted electronic document corresponding to the redacted portion.

9. The method of claim 8 wherein the specified user action is one of a group consisting of: user selection of an item representative of the redacted portion within the redacted electronic document, scrolling past an item representative of the redacted portion within the redacted electronic document, gazing on an item representative of the redacted portion within the redacted electronic document, and dwelling on an item representative of the redacted portion within the redacted electronic document for more than a predefined amount of time.

10. A user device comprising:
a communication interface communicatively coupling the user device to a network; and
a control system associated with the communication interface and adapted to:
obtain a redacted electronic document having a redacted portion via the network;
provide access to the redacted electronic document to a user at the user device;
detect a triggering event defined by a callback trigger associated with the redacted portion of the redacted electronic document during consumption of the redacted electronic document by the user;
perform a callback action defined by the callback trigger in response to detecting the triggering event such that the user is granted access rights to the redacted portion of the redacted electronic document; and
provide access to the redacted portion of the redacted electronic document after the user is granted access rights to the redacted portion of the redacted electronic document.

11. A method of operation of a computing device comprising:
redacting an electronic document to provide a redacted electronic document having a redacted portion;
associating a callback trigger with the redacted portion of the redacted electronic document, the callback trigger defining a triggering event and a callback action to be performed in response to detection of the triggering event during consumption of the redacted electronic document by a consumer to enable the consumer to gain access rights to the redacted portion; and
enabling a user device of a consumer to obtain the redacted electronic document and the callback trigger.

12. The method of claim 11 wherein redacting the electronic document comprises determining a portion of the electronic document to be redacted from the electronic document to provide the redacted electronic document having the redacted portion.

13. The method of claim 12 wherein determining the portion of the electronic document to be redacted comprises receiving user input from a user that manually identifies the portion of the electronic document to be redacted.

14. The method of claim 12 wherein determining the portion of the electronic document to be redacted comprises processing the electronic document based on one or more redaction criteria to automatically determine the portion of the electronic document to be redacted.

15. The method of claim 14 wherein the one or more redaction criteria comprise one or more generic redaction criteria used for all electronic documents including the electronic document.

16. The method of claim 14 wherein the one or more redaction criteria comprise one or more document specific redaction criteria used only for the electronic document.

17. The method of claim 14 wherein the one or more redaction criteria comprise one or more user-based redaction criteria such that the redacted portion of the redacted electronic document is a function of one or more characteristics of the consumer.

18. The method of claim 14 wherein the one or more redaction criteria comprise one or more content-based redaction criteria such that the redacted portion of the redacted electronic document is a function of content of the electronic document.

19. The method of claim 14 wherein the one or more redaction criteria comprise one or more context-based redaction criteria such that the redacted portion of the redacted electronic document is a function of at least one of a group consisting of: a location of the consumer at the time the consumer obtains the redacted electronic document, a time of day at which the consumer obtains the redacted electronic document, and a date on which the consumer obtains the redacted electronic document.

20. The method of claim 11 wherein the computing device is part of a central system, and enabling the user device of the consumer to obtain the redacted electronic document and the callback trigger comprises:
receiving a document request from the user device of the consumer via a network; and
sending the redacted electronic document and the callback trigger to the user device of the consumer in response to the document request via the network.

21. The method of claim 20 wherein redacting the electronic document comprises removing the redacted portion from the electronic document to provide the redacted electronic document.

22. The method of claim 20 wherein redacting the electronic document comprises controlling access to the electronic document via a Digital Rights Management (DRM) scheme to prevent access to the redacted portion to thereby provide the redacted electronic document.

23. The method of claim 20 wherein redacting the electronic document comprises redacting the electronic document in response to the document request.

24. The method of claim 20 wherein redacting the electronic document comprises redacting the electronic document prior to the document request.

25. The method of claim 11 wherein the computing device is a user device associated with a creator of the electronic document.

26. The method of claim 25 wherein enabling the user device of the consumer to obtain the redacted electronic document and the callback trigger comprises:
providing the electronic document, redaction data that identifies the redacted portion of the electronic document, and the callback trigger associated with the redacted portion to a central system,
wherein the central system provides the redacted electronic document and the callback trigger to the user device of the consumer upon request.

27. The method of claim 26 wherein the central system removes the redacted portion of the electronic document identified by the redaction data from the electronic document to provide the redacted electronic document.

28. The method of claim 26 wherein the central system utilizes a Digital Rights Management (DRM) technique to enable the consumer to access the electronic document other than the redacted portion to thereby provide the redacted electronic document.

29. A computing device comprising:
a communication interface communicatively coupling the computing device to a network; and
a control system associated with the communication interface and adapted to:
redact an electronic document to provide a redacted electronic document having a redacted portion;
associate a callback trigger with the redacted portion of the redacted electronic document, the callback trigger defining a triggering event and a callback action to be performed in response to detection of the triggering event during consumption of the redacted electronic document by a consumer to enable the consumer to gain access rights to the redacted portion; and
enable a user device of a consumer to obtain the redacted electronic document and the callback trigger.
